(19) United States
(12) Patent Application Publication
(10) Pub. No.: US 2024/0132360 A1
(43) Pub. Date: Apr. 25, 2024

(54) SOLID-STATE BATTERY ANODE COMPOSITION

(71) Applicant: Talga Technologies Limited, Cambridge (GB)

(72) Inventors: Claudio CAPIGLIA, Osaka (JP); Fengming LIU, Reading (GB); Sai SHIVAREDDY, Cambridge (GB)

(21) Appl. No.: 18/547,810

(22) PCT Filed: Feb. 24, 2022
(86) PCT No.: PCT/IB2022/051613

§ 371 Date: Aug. 23, 2023

(30) Foreign Application Priority Data
Feb. 24, 2021 (AU) 2021900501

(51) Int. Cl. C01B 32/20

(52) U.S. Cl. CPC C01B 32/20; C01P 2002/72; C01P 2004/03; C01P 2004/61; C01P 2006/12; C01P 2006/40

(57) ABSTRACT

A solid-state battery anode composition comprising a graphitic material and a solid electrolyte material, wherein the graphitic material is provided in the form of ground primary graphite particles. A method for producing a solid-state battery anode comprising an anode composition is also described.

### FIELD OF THE INVENTION

The present invention relates to a solid-state battery anode composition. More particularly, the present invention further relates to an anode composition comprising a graphitic material and solid electrolyte material.

The present invention still further relates to a method for producing a solid-state battery anode comprising an anode composition in accordance with the present invention.

### BACKGROUND ART

Presently, Lithium-ion battery (LiB) technology has been successfully used in applications for electric devices including cell phones, laptops, tablets, and also for electric vehicles (PHEV, EV). However, LiBs suffer safety concerns due to their flammable liquid electrolyte. Solid-state batteries are an emerging form of rechargeable battery technology with the potential to combine high energy and high power with improved safety. In this sense, all solid-state batteries (SSBs) are of great interest due to their intrinsic safety and wide range of operating temperatures, largely due to the non-flammable solid electrolyte of choice. Moreover, SSBs provide benefits concerning high gravimetric and volumetric energy density [1,2]. Unlike LiBs that utilise a porous separator soaking within a liquid electrolyte, SSBs use a solid electrolyte which has a function as an electrical insulator and ionic conductor. The components of the electrolyte consist of solid materials with less, similar or higher ionic conductivity than liquid electrolyte [3,4].

The idea of a solid-state electrolyte for manufacturing solid-state batteries was initially proposed in the 1970s by Professor Wright who first reported fast ionic conduction in high molecular weight polyethylene oxide (CH₂CH₂O)ₙ [5] and the work of Armand et al. [6] in the 1990s. Then Capiglia et al. proposed the utilization of SiO₂ nano-composite polymer electrolyte for SSBs and their application in EV and HEV [7]. Since then, there have been many studies to improve ionic conductivity in solid electrolyte considering different types of polymers, ceramics and sulfide glass based solid electrolyte. One of the most promising solid electrolytes are the sulfide-based glasses, including Li₂S—SiS₂ [8,9,10,11], Li₂S—P₂S₅ [12,13,14,15], and Li₂S—B₂S₃ [16].

While solid-state batteries are theoretically capable of very high performance, in practice they can suffer a range of technical and commercial issues that have hindered their development, particularly for larger scale applications including electric vehicles (“EVs”). None of the solid-state batteries reported to date exceed all of the performance and economic requirements of today's best Li-ion batteries in EVs. A major bottleneck of SSBs development is the anode, where the use of metallic lithium can cause a range of issues leading to slower charge/discharge characteristics, safety issues both within the battery and in mass production, and higher cost. Takada et al. proposed a graphite-solid electrolyte construction by using Li₂S—P₂S₅ electrolyte and Seino et al. investigated the graphite-Li₂S—P₂S₅ based solid-state battery under pressure of 350 MPA. Those approaches showed a practicality of application of the graphite as anode material in the solid-state battery. However, the electrochemical characteristics of such a construction was still untested.

The solid-state battery anode composition and method of the present invention have as one object thereof to overcome substantially one or more of the above-mentioned problems associated with prior art processes, or to at least provide a useful alternative thereto.

The preceding discussion of the background art is intended to facilitate an understanding of the present invention only. This discussion is not an acknowledgement or admission that any of the material referred to is or was part of the common general knowledge as at the priority date of the application.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

### DISCLOSURE OF THE INVENTION

In accordance with the present invention there is provided a solid-state battery anode composition comprising a graphitic material and a solid electrolyte material, wherein the graphitic material is provided in the form of ground primary graphite particles.

The ground primary graphite particles preferably have a D₅₀ of:
(i) less than about 15 microns;
(ii) less than about 10 microns; or
(iii) in the range of about 4 to 6 microns.

Preferably, the ground primary graphite particles have a surface area of about 2 to 9 m²/g, for example 7 to 9 m²/g.

Preferably, the ground primary graphite particles have XRD characteristics of one or more of a d002 of >3.35 Å, an Lc of >1000 Å and an La of >1000 Å. In a preferred form, the ground primary graphite particles have XRD characteristics of each of a d002 of >3.35 Å, an Lc of >1000 Å and an La of >1000 Å, and a purity of >99.9%.

Preferably, the solid electrolyte material comprises a sulphide-based glass. Still preferably, the sulphide-based glass is chosen from the group of Li₂S—SiS₂, Li₂S—P₂S₅ and Li₂S—B₂S₃. Still further preferably, the solid electrolyte material comprises Li₂S—P₂S₅.

The solid-state battery anode composition of the present invention preferably comprises a graphitic material and a solid electrolyte material in the following proportions:
(i) Graphitic material 70 to 90 wt %; and
(ii) Solid-electrolyte material 10 to 30 wt %.

Preferably, the solid-state battery anode composition of the present invention provides, in half cell measurements using the Current Rest Method, an equilibrium component of less than about 60 Ohm, for example less than about 54 Ohm. The equilibrium component of the solid-state battery anode composition in half cell measurements using the Current Rest Method is preferably about half or less that of known commercial graphite materials.

Preferably, the solid-state battery anode composition of the present invention provides a conductivity of 10˜2×10 S/cm over a compression density range of 0.5˜2 g/cm³. The conductivity of the solid-state battery anode composition is preferably about one order of magnitude higher than that of known commercial graphite materials.

Preferably, the graphitic material has a graphitisation degree of greater than 96%.

Still preferably, the graphitic material has a bulk resistance of:
(i) About 359.5Ω at 100 MPa;
(ii) About 94.7Ω at 300 MPa; or
(iii) About 73.5Ω at 500 MPa.

Preferably, the solid-state battery anode composition of the present invention provides, in half cell measurements, a capacity of greater than 90% at 3 C, for example about 91.6% at 3 C.

Preferably, the solid-state battery anode composition of the present invention provides, in half cell measurements, a discharge profile substantially free of polarisation effects.

In accordance with the present invention there is further provided a method for producing a solid-state battery anode comprising an anode composition that in turn comprises a graphitic material and a solid electrolyte material, as described hereinabove.

### BRIEF DESCRIPTION OF THE DRAWINGS

The present invention will now be described, by way of example only, with reference to two embodiments thereof and the accompanying drawings, in which:—

FIG. 1 is a scanning electron microscope (SEM) image of an anode material of the present invention comprising secondary graphite particles predominantly having a form that approximates an oblate spheroid;

FIG. 2 is a schematic representation of a method for the production of a solid-state battery anode and cell incorporating that solid-state battery anode in accordance with the present invention;

FIG. 3 is a graphical representation of AC impedance in a half cell produced by way of the method of FIG. 2 in accordance with the Example described herein;

FIG. 4 is a graphical representation of the charging/discharging profiles of the half cell produced by way of the method of FIG. 2 in accordance with the Example described herein, including implementation of DC internal resistance evaluation by the “current pause method” proposed by Yata et al. [19];

FIG. 5 is a graphical representation of the relationship between pressure and mixture density of the solid-state battery anode composition of the present invention;

FIG. 6 is a graphical representation of the relationship between the density and electrical conductivity of the solid-state battery anode composition of the present invention;

FIG. 7 is a series of graphs showing AC electrochemical impedance measurements prior to charging, utilising Nyquist plots;

FIG. 8 is series of graphs showing discharge curves at 0.1 C to 3.0 C for the solid-state battery anode composition of the present invention;

FIG. 9a shows a Nyquist plot and FIG. 9b an equivalent circuit model, in accordance with the Example described herein, R₂ indicating bulk resistance and R₁ charge transfer resistance, W indicating Warburg element and C₁ capacitor; and

FIG. 10 is a graphical representation of ionic conduction and charge/discharge achieved in the half cell referenced in FIG. 4, showing each of an ohmic component, an equilibrium component and the resting resistance, together with data for State of Charge (SOC) and Open Circuit Voltage (OCV).

### BEST MODE(S) FOR CARRYING OUT THE INVENTION

The present invention provides a solid-state battery anode composition comprising a graphitic material and a solid electrolyte material. The graphitic material comprises ground primary graphite particles.

The ground primary graphite particles may have a D₅₀ of:
(i) less than about 15 microns;
(ii) less than about 10 microns; or
(iii) in the range of about 4 to 6 microns.

The ground primary graphite particles have a surface area of about 2 to 9 m²/g, for example 7 to 9 m²/g. The ground primary graphite particles have XRD characteristics of one or more of a d002 of >3.35 Å, an Lc of >1000 Å and an La of >1000 Å. In a preferred form, the ground primary graphite particles have XRD characteristics of each of a d002 of >3.35 Å, an Lc of >1000 Å and an La of >1000 Å, and a purity of >99.9%.

The solid electrolyte material comprises a sulphide-based glass. The sulphide-based glass is chosen from the group of Li₂S—SiS₂, Li₂S—P₂S₅ and Li₂S—B₂S₃. For example, the solid electrolyte material comprises Li₂S—P₂S₅.

In one preferred form, the solid-state battery anode composition of the present invention comprises a graphitic material and a solid electrolyte material in the following proportions:
(i) Graphitic material 70 to 90 wt %; and
(ii) Solid-electrolyte material 10 to 30 wt %.

The solid-state battery anode composition of the present invention provides in one form, in half cell measurements using the Current Rest Method, an equilibrium component of less than about 60 Ohm, for example less than about 54 Ohm. The equilibrium component of the solid-state battery anode composition in half cell measurements using the Current Rest Method is in one form about half or less that of known commercial graphite materials.

The solid-state battery anode composition of the present invention provides a conductivity of 10˜2×10 S/cm over a compression density range of 0.5˜2 g/cm³. The conductivity of the solid-state battery anode composition is about one order of magnitude higher than that of known commercial graphite materials.

The solid-state battery anode composition of the present invention provides, in half cell measurements, a capacity of greater than 90% at 3 C, for example about 91.6% at 3 C.

The solid-state battery anode composition of the present invention provides, in half cell measurements, a discharge profile substantially free of polarisation effects.

The present invention further provides a method for producing a solid-state battery anode comprising an anode composition that in turn comprises a graphitic material and a solid electrolyte material, as described hereinabove and exemplified hereinafter.

Table A below provides an example of an appropriate ground primary graphite particle for use in/as used in the composition and method of the present invention, whilst Table B provides the elemental analysis of that ground primary graphite particle.

TABLE A

| Property | Value | | Method |
|---|---|---|---|
| Carbon Content | >99.9% | | LECO (C %, S %). Loss of Ignition |
| | | | (LOI) |
| Surface Area | 2-9 | m²/g | Bernauer-Emmett-Teller (BET) |
| Particle size | 3-15 | μm | Particle size analyzer |
| D₁₀ | 1~3 | μm | |
| D₅₀ | 4~6 | μm | |
| D₉₀ | 7-10 | μm | |
| Bulk Density | 0.2-1 | g/cc | Bulk density apparatus |
| d1002 | >3.35 | Å | XRD |
| Lc | >1000 | Å | |
| La | >1000 | Å | |

TABLE B

| C | Al | Ca | Cu | Fe | K | Mg | Mn | Si | S | ELEMENTS |
|---|---|---|---|---|---|---|---|---|---|---|
| >99.9% | 3.3 | 7.4 | 7.3 | 26.7 | 5.7 | 2.9 | 0.2 | <0.1 | 37 | ppm |

The composition and method of the present invention may be better understood with reference to the following non-limiting example.

### Example

The anode graphite anode precursor used for the present investigation was extracted from the Vittangi graphite mine in the County of Norrbotten in northern Sweden. This natural graphite source is characterised by hard particles having a very narrow distribution, with microcrystalline flake. The graphite was then chemical purified at the Applicant's pilot plant in Rudolstadt and process engineered to be applied in the solid-state system. This process is as described hereinabove for the production of ground primary graphite particles and in turn secondary graphite particles (variously also referred to herein as ‘Talnode-E’, ‘Talnode-E powder’ or ‘Talnode-C’ throughout).

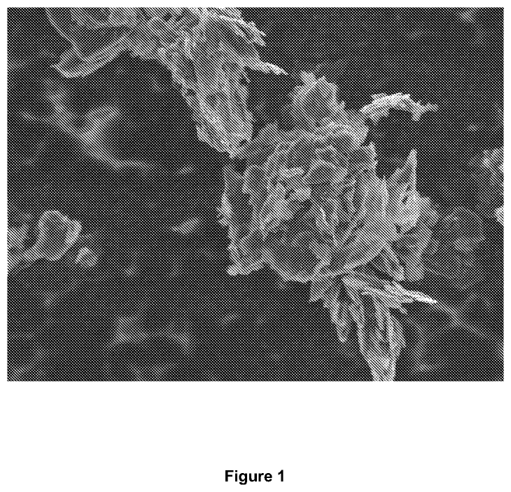

The SEM images of FIG. 1 show that Talnode-E powder, the ground primary graphite particles, consists of relatively small particles, having a D₅₀ of less than about 5 microns, and smaller ones (about 1 μm) with a flake shape and they seemed partly to form agglomerates with the size of about 10 μm.

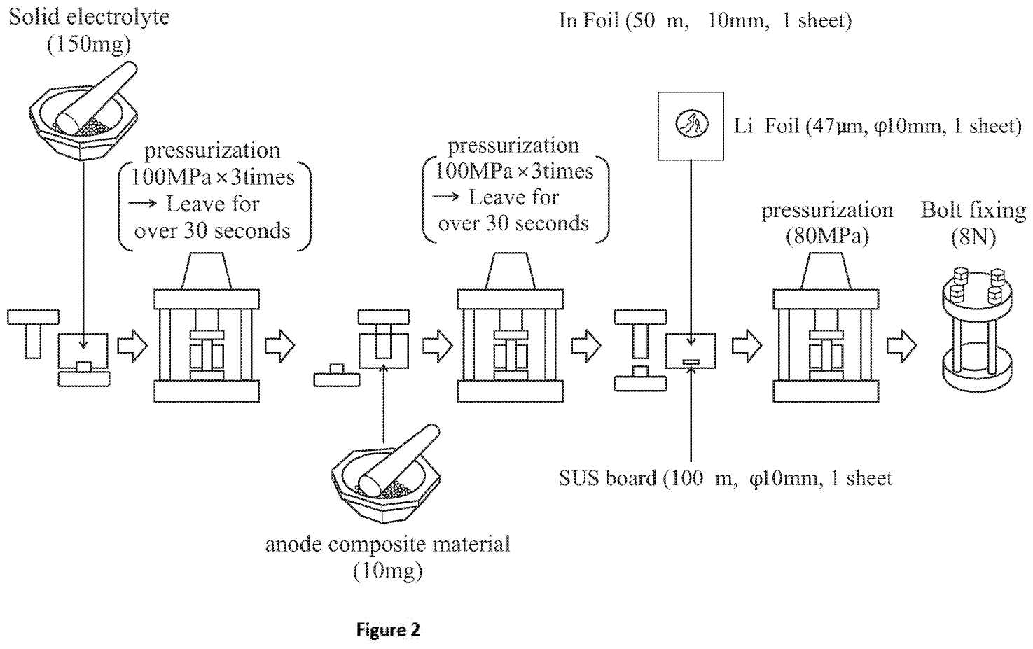

Solid electrolyte pellets were prepared in accordance with the method of the present invention, with reference to FIG. 2, using a custom-made Teflon mold and steel holder. The electrolyte pellets were composed of Li₂S—P₂S₅ and obtained by the hydraulic press of the powder at the fabrication pressure for 3 minutes. The electrode anode composite pellet based on Talnode-E was instead prepared using 54.3 mg of the electrolyte powder and 45.7 mg of the Talnode-E anode graphite and pressed.

The cell was prepared by sandwiching the solid electrolyte, the solid electrode pellets, the lithium-indium between SUS electrodes at a varying stack pressure of 100, 300, and 500 MPa. The indium and lithium foils pressed was used as reference electrode for the half cell. The steel holder (SUS) was used as current collectors. In order to allow control of the stack pressure during Electrochemical Impedance Spectroscopy (EIS) measurement and cycling, the cell was assembled in the cell holder described in FIG. 2.

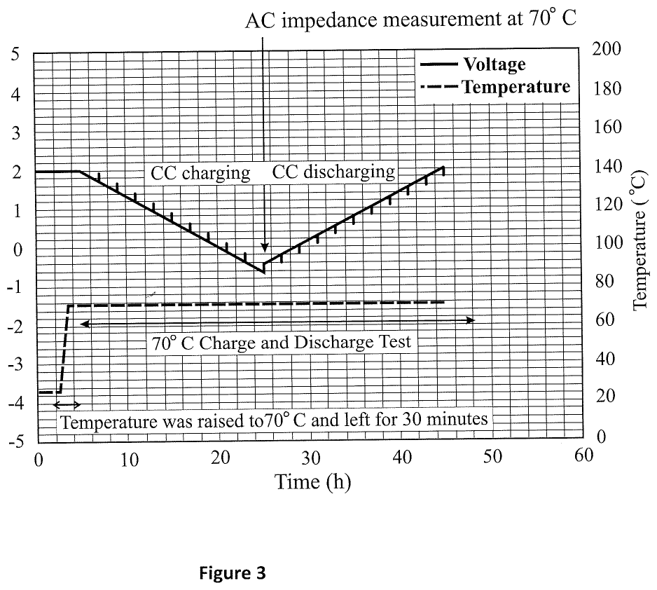

The half-cell obtained was cycled with cut-off voltages between 2.0V and −0.62 V versus Li—In at 0.05 C. The cell was kept at 70° C.±1° C. and had a 10 min pause for every 2 h during testing. Electric conductivities of the samples were measured at 70° C. by an A.C. impedance method. The impedance spectra were measured using an impedance analyzer (VeraSTAT4 Princeton Applied Research) in the frequency range from 0.1 Hz to 1 MHz, amplitude 50 mV, the results of which are set out in FIG. 3.

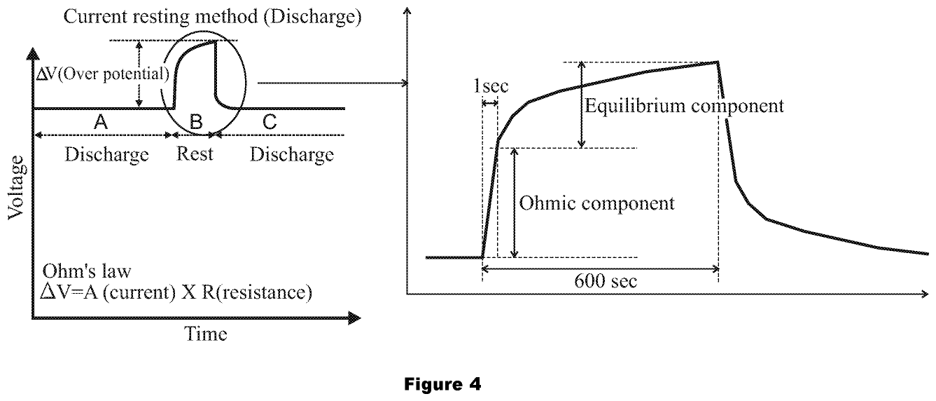

With reference to FIG. 4, the charging/discharging profiles of the cell for the Current Resting Method (CRM) were measured between a voltage from −0.62V to 2.0V (current rate of 0.05 C at 70° C.). At first, the fully discharged cells were charged at a constant current with a rate of 0.05 C for 120 minutes and stopping the charging current for 600 seconds. In the charging process, this charging-rest procedure was repeated until the cell voltage reached −0.62V. After a 1-hour rest, the discharging of the 120 minutes and the 600 seconds was repeated until the cell voltage reached 2.0V. The current resting resistance was measured through the voltage change from 0 to 600 seconds. The Ohmic component (resistance) was calculated from 0 to 1 second and equilibrium component (resistance) from 0 to 600 seconds.

The Kyoto Research Institute used the same protocol for electrode, electrolyte preparation, as well as the impedance, and CRM characterisation for all other types of graphite in commerce and therefore Talnode-E was benchmarked versus typical commercial anode graphite. Such typical commercial anode graphite is, as noted elsewhere herein, based on about 200 types of graphite including both natural and artificial with a particle size ranging from 10 μm to 20 μm.

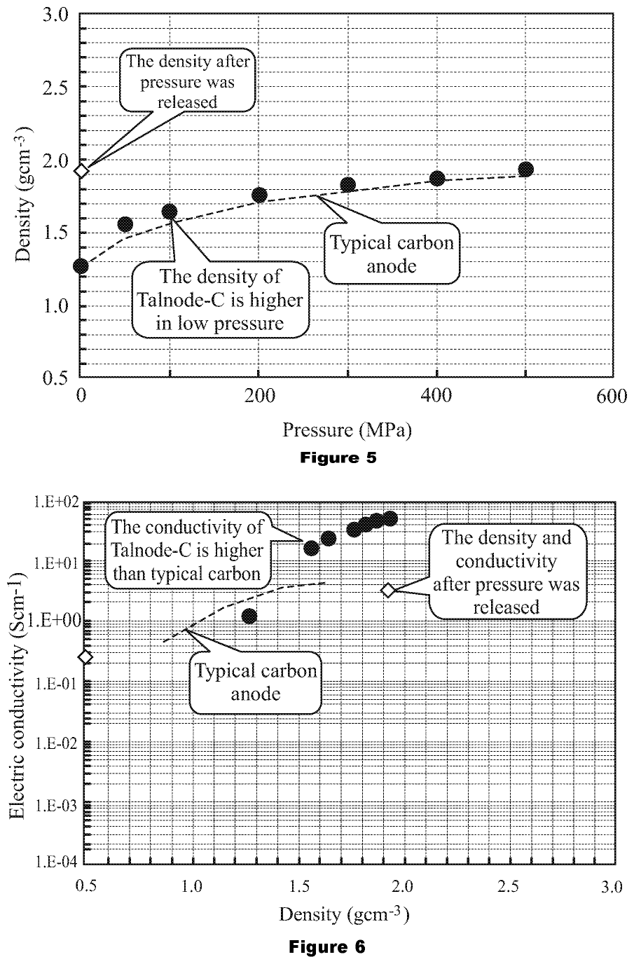

FIG. 5 shows the correlation of the relative density of the Talnode-E electrode and the pressure. In a 10 mm diameter mould, the mixed powder of solid electrolyte and graphite was uniaxial compressed. The pressure influences the density of the electrolyte material. While increasing the stack pressure from 0 to 500 MPa, the relative density increases from 1.3 to 2 gcm-3. The density increases with increasing applied pressure. The black dots represent the density dependence of Talnode-E with pressure. To compare the material property of the graphite anode materials, the typical behaviour of commercial graphite is reported for comparison as a dotted line. The typical graphite material has a similar trend concerning a correlation between the density and stack pressure, but Talnode-E has a higher density at low pressure which indicate that Talnode-E has higher loading at low pressure when compared versus typical commercial graphite. Therefore, the combination of solid-state electrolyte with Talnode-E provided a surprisingly high-density electrode by pressing when compared with typical graphite. The Applicants believe this behaviour to be related to the unique morphology of Talnode-E.

In FIG. 6 electric conductivity versus density is shown and is determined by an amperemeter. While increasing the density of the electrode from 1.2 to 2 gcm-3, the electric conductivity of the electrolyte increases from 1.27 to 48.7 Scm-1. These results confirm that the pressure on the solid electrolyte influences the measured electric conductivity by improving the grain boundary contact between the solid-state electrolyte and the graphite. The trend of electric conductivity increases similarly to the trend of density. Further, increasing the stack pressure impacts in a relatively small manner the density of the pellet, and therefore the porosity which moves from 21% of the solid electrode has a limited effect on the electric conductivity. The commercial graphite materials, based on about 200 types of graphite including both natural and artificial with a particle size ranging from 10 μm to 20 μm, have a similar trend concerning a correlation between the density and electric conductivity, but Talnode-E shows almost one order of magnitude higher electric conductivity than one of the typical known commercial graphite. It is understood by the Applicant that this result may be related to the high graphitization degree (higher than 96%) and volume density of Talnode-E [20]. The current behaviour of the cells is investigated further by using EIS and CRM in Table C below.

TABLE C
Bulk Resistance Measurement by Amperemeter

| | Bulk Resistance | Bulk Resistance | Bulk Resistance |
|---|---|---|---|
| | at 100 MPa | at 300 MPa | at 500 MPa |
| Talnode-E | 359.5Ω | 94.7Ω | 73.5Ω |

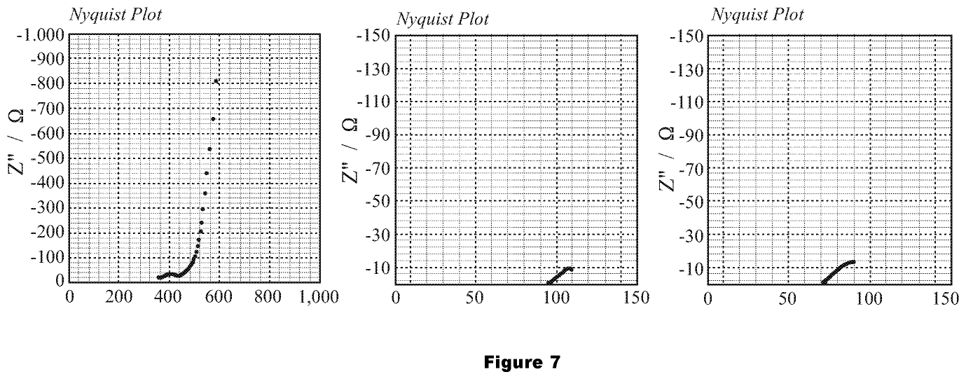

In FIG. 7 there are shown AC electrochemical impedance spectra. An equivalent circuit model is generally chosen to understand and analyse the electrochemical reaction in a battery cell. The circuit model consists of electrical circuit elements such as resistors (R), capacitors (C), inductors (L), constant phase element (CPE), and Warburg element (W). The constant phase element and the Warburg element are beneficial to characterize the non-ideal capacitor and lithium diffusion effect. Because of the characteristics of a double layer between the rough surfaces of electrode and electrolyte, the non-ideal property can be described by using the concept of CPE. The Warburg element was used to explain the impedance of the lithium diffusion process. If the cell has characteristics of the capacitor, it shows a 90° of diffusivity, and other cases show a 45° of diffusivity.

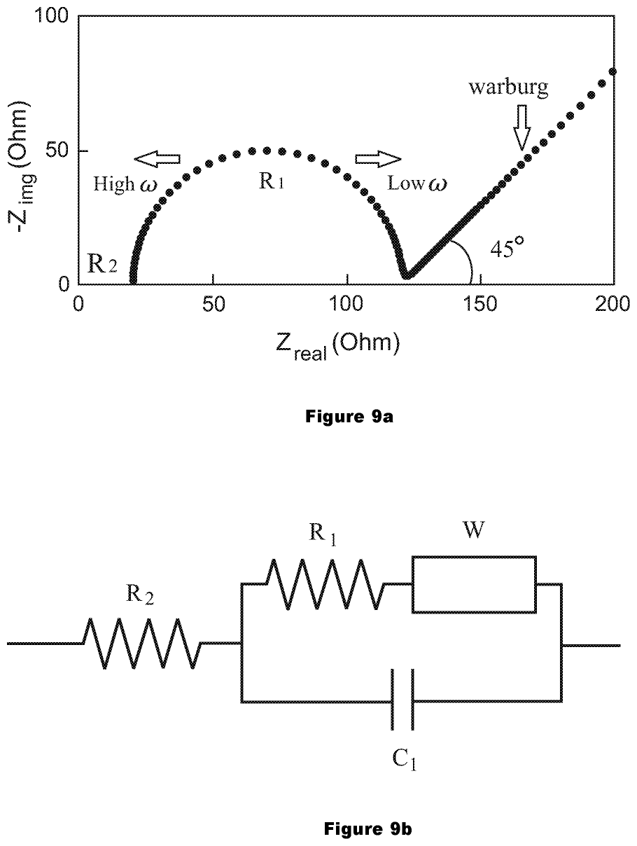

A simplified model, which is made by those elements, is called a Randles model, who presented the model at the Faraday society in 1947. A plot, which was imagined by the Randles model, is called the Nyquist plot. In the Nyquist plot, the characteristics of a cell are visibly illustrated. This model is indispensable for understanding an electrochemical system. However, real systems are very complicated and convoluted. The Nyquist plot of a simplified Randles cell is depicted in FIG. 9a, with FIG. 9b showing an equivalent circuit model for the cell. The R₂ is designated Ohmic or bulk resistance, which includes a resistance of the electrolyte, current collector, and separator. The R₁ is designated charge transfer or polarisation resistance, which represents a resistance between active material and electrolyte.

Against this theoretical background, it is explained that the stack pressures impact on the semicircles (charge transfer resistance) and the diffusion part on EIS for Talnode-E. The emergence of a semicircle at the high-resistance region shifted to the low resistance (bulk resistance) region as the stack pressure increases. Additionally, the semicircle decreased when the stack pressure exceeds over 300 MPa. The grain boundaries of impedance can contribute to the emerging of a semicircle at the high-frequency region. Similar behaviour has been observed on oxide solid-state electrolytes. As the pellet's density increased by sintering, the grain boundary resistance reduced, and therefore, the conductivity increased [26,27]. It is interesting to see that the diffusion curve shows a steep slope of diffusivity at 100 MPa, while the slopes of the other two cases do not show such a steep slope at this pressure.

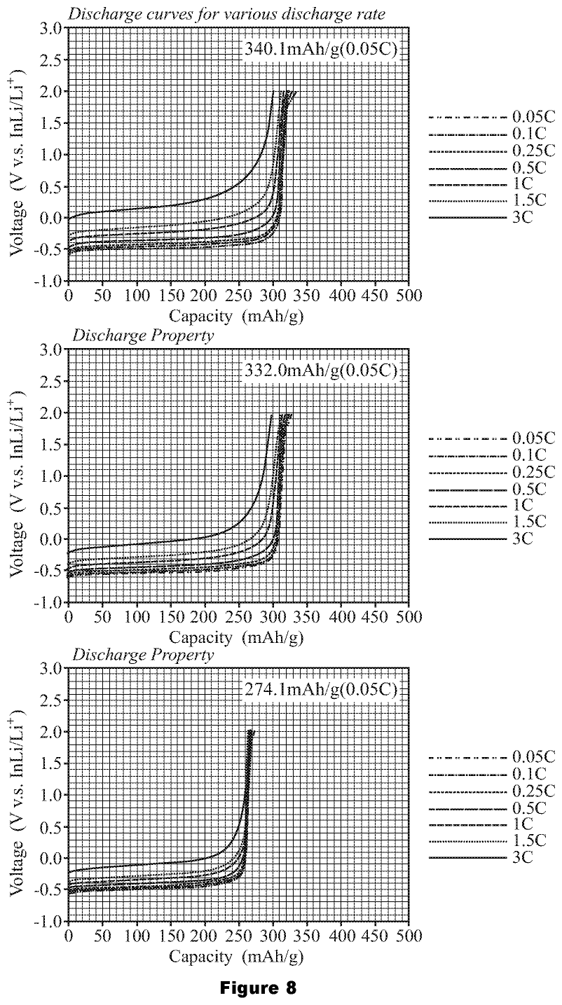

The high-rate test between 0.05 C and 3 C at 70° C. of Talnode-E was tested using a stack pressure of 100, 300, and 500 MPa, and the results thereof are shown in FIG. 8. The capacity of the half-cell at 100 and 300 MPa are largely similar. There are slight differences in Columbic in discharge capacity (337 mAh·g-1 and 324 mAh·g-1) at 0.05 C during the first cycle. However, the cell, which was measured with a pressure of 500 MPa, on the other hand, shows a significantly lower specific capacity of only 277 mAh·g-1 compared to the other two cases with 40-50 mAh·g-1, a difference that the Applicant has attributed to a change of morphology. However, it is noticed that all three cases showed high performance on the high C-rate test. In particular, a capacity retention of 97.7% with low polarization curve profile of discharge was achieved. This behaviour indicated to the Applicant that the low internal resistance of Talnode-E, especially charge transfer resistance and high diffusion coefficient of lithium as discussed hereinafter on the CRM measurements, of the anode material might assist the high C-rate performance [20]. The further investigation on the low internal resistance and lithium ion diffusion in the anode material is conducted further through the CRM method.[21]

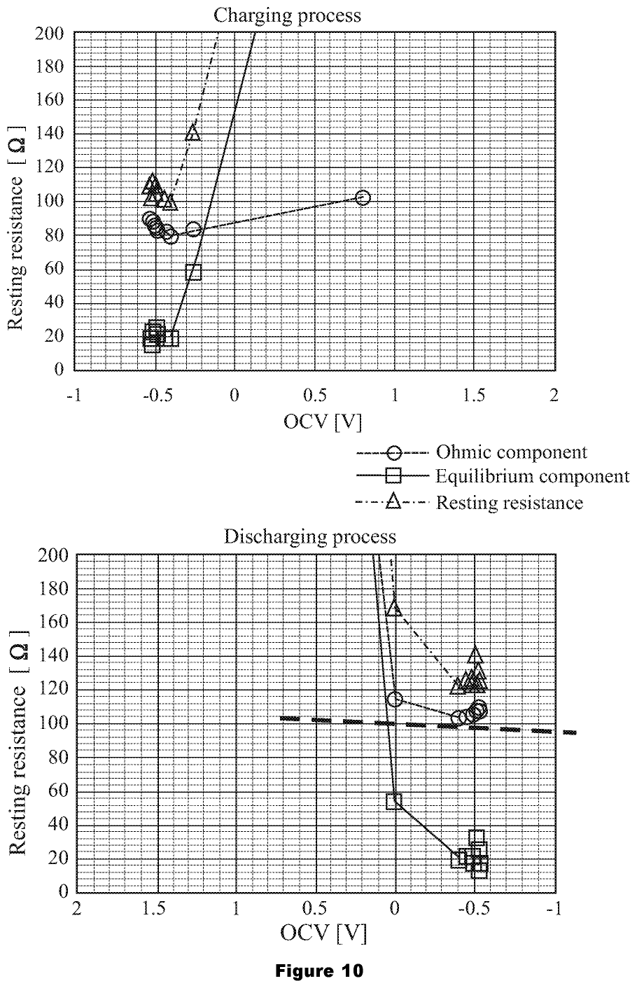

FIG. 10, and Tables D and E below, show the relationships between total internal resistance, OCV and SOC. The experiment samples were operated at 70° C. with different stack pressure. The experimental results showed that the internal resistance of the samples varied with the battery's SOC. The resistance of Ohmic and equilibrium component decreased along the SOC. and had a minimum value when the battery capacity was 70%-80%. However, the resistances increased again at 90% of SOC. The descending nature of the internal resistances during the most of SOC (approximately from 10 to 70%) are relatively small and resulting curves would demonstrate a flattened parabolic shape. This phenomenon is consistent with the internal resistance characteristics of the hybrid pulse power characterization test [22]. It is understood that this effect may be caused by a kinetics and mass transport behaviour [19].

TABLE D

| | | | Resistance by charging process resting | | |
|---|---|---|---|---|---|
| | | | method [Ω] | | |
| Resting | SOC | OCV | Ohmic | Equilibrium | Resting |
| point | [%] | [V] | component | component | resistance |
| 1 | 90 | 0.795 | 102.9 | 433.4 | 536.3 |
| 2 | 80 | −0.266 | 83.5 | 57.8 | 141.2 |
| 3 | 70 | −0.406 | 80.0 | 19.3 | 99.2 |
| 4 | 60 | −0.440 | 82.4 | 19.3 | 101.7 |
| 5 | 50 | −0.486 | 83.1 | 21.2 | 104.3 |
| 6 | 40 | −0.496 | 83.7 | 21.2 | 104.9 |
| 7 | 30 | −0.502 | 85.3 | 25.0 | 110.3 |
| 8 | 20 | −0.515 | 88.6 | 23.1 | 111.7 |
| 9 | 10 | −0.526 | 86.9 | 15.4 | 102.3 |
| 10 | 0 | −0.530 | 89.8 | 19.3 | 109.1 |

TABLE E

| | | | Resistance by charging process resting | | |
|---|---|---|---|---|---|
| | | | method [Ω] | | |
| Resting | SOC | OCV | Ohmic | Equilibrium | Resting |
| point | [%] | [V] | component | component | resistance |
| 1 | 0 | −0.528 | 108 | 17 | 126 |
| 2 | 10 | −0.522 | 110 | 13 | 123 |
| 3 | 20 | −0.519 | 107 | 25 | 133 |
| 4 | 30 | −0.507 | 108 | 33 | 141 |
| 5 | 40 | −0.488 | 106 | 17 | 123 |
| 6 | 50 | −0.483 | 106 | 21 | 127 |
| 7 | 60 | −0.450 | 105 | 21 | 126 |
| 8 | 70 | −0.393 | 104 | 19 | 123 |
| 9 | 80 | 0.005 | 115 | 54 | 169 |
| 10 | 90 | 1.583 | 1444 | 1998 | 3442 |

As can be seen with reference to the above description, the Talnode-E electrochemical properties in sulfide-solid-state electrolyte were studied at different pressures and compared with typical commercial graphite. Talnode-E electrode shows a capacity of 324.1 mAh/g at 300 MPa. Furthermore, Talnode-E showed an increase in the electric conductivity of approximately one order of magnitude compared to the commercial graphite thanks to the high electrical conductivity of Talnode-E. High rate tests have shown that Talnode-E has high rate discharge capability associated with high capacity retention up to 3 C and low polarization discharge curve profiles. The behaviour was attributed to the high lithium diffusion of Talnode-E when compared with conventional graphite.

The Applicant has concluded that Talnode-E has high potential to be used as an alternative anode material with low resistance and high ionic diffusion in at least sulfide-based-solid-state batteries. Further, the solid-state battery anode composition of the present invention suggests significant improvements in energy density and cycle life while enabling faster charging with improved safety (for example no flammable solvents), all whilst maintaining broad compatibility with the most near-term forms of solid-state batteries.

The use of graphitic anodes in solid-state batteries also helps ensure suitable interaction at the electrolyte/active material interface to mitigate prior persistent issues such as high impedance and mechanical fatigue.

It is envisaged that by replacing current lithium metal anodes with a solid-state battery anode composition of the present invention, the cost of solid-state batteries can be reduced, as can the associated hurdle of manufacturing at scale.

It is to be understood that the ranges provided herein include the stated range and any value or sub-range within the stated range. For example, a range from about 1 micrometer (μm) to about 2 μm should be interpreted to include not only the explicitly recited limits of from between from about 1 μm to about 2 μm, but also to include individual values, such as about 1.2 μm, about 1.5 μm, about 1.8 μm, etc., and sub-ranges, such as from about 1.1 μm to about 1.9 μm, from about 1.25 μm to about 1.75 μm, etc. Furthermore, when “about” and/or “substantially” are/is utilised to describe a value, they are intended to encompass minor variations (up to +/−10%) from the stated value.

The forgoing description is to be considered non-limiting. Modifications and variations such as would be apparent to the skilled addressee are considered to fall within the scope of the present invention.

### REFERENCES

1. J. Janek and W. G. Zeier, Nat. Energy, 2016, 1, 16141
2. C. Cao, Z.-B. Li, X.-L. Wang, X.-B. Zhao and W.-Q. Han, Frontiers in Energy Research, 2014, 2, 1-10
3. A. Varzi, R. Raccichini, S. Passerini and B. Scrosati, J. Mater. Chem. A, 2016, 4, 17251-17259
4. Y. Kato, S. Hori, T. Saito, K. Suzuki, M. Hirayama, A. Mitsui, M. Yonemura, H. Iba and R. Kanno, Nat. Energy, 2016, 1, 16030
5. P. V. Wright, British Polym. J., 1975, 7, 319-327
6. M. Armand, Solid-state Ionics, 1983, 9-10, Part 2, 745-754
7. Capiglia, C. Solid-state Ionics 1999, 118 (1-2), 73-79
8. M. Tatsumisago, H. Morimoto, H. Yamashita, T. Minami, Solid-state Ionics 136-137 (2000) 483.
9. A. Hayashi, M. H. Yamashita, T. Tatsumisago, Solid-state Ionics 148 (2002) 381.
10. A. Hayashi, R. Komiya, M. Tatsumisago, T. Minami, Solid-state Ionics 152-153 (2002) 285.
11. M. Tatsumisago, S. Hama, A. Hayashi, H. Morimoto, T. Minami, Solid-state Ionics 154-155 (2002) 635.
12. R. Mercier, J.-P. Malugani, Fahsy G. Robert, Solid-state Ionics 5 (1981) 663.
13. A. Hayashi, S. Hama, H. Morimoto, M. Tatsumisago, T. Minami, J. Am. Ceram. Soc. 84 (2001) 477.
14. M. Tatsumisago, S. Hama, A. Hayashi, H. Morimoto, T. Minami, Solid-state Ionics 154-155 (2002) 635.
15. A. Hayashi, S. Hama, T. Minami, M. Tatsumisago, Electrochem. Commun. 5 (2003) 111.
16. H. Wada, M. Menetrier, A. Levasseur, P. Hagenmuller, Mater. Res. Bull. 18 (1983) 189
17. Takada, K. Solid-state Ionics 2003, 158 (3-4), 269-274.
18. Seino, Y.; Takada, K.; Kim, B.-C.; Zhang, L.; Ohta, N.; Wada, H.; Osada, M.; Sasaki, T. Solid-state Ionics 2005, 176 (31-34), 2389-2393.
19. Yata, S.; Mori, S.; Satake, H. ECS Transactions; ECS: Honolulu, H I, 2008; Vol. 16, pp 13-24.
20. Rattanaweeranon, S.; Limsuwan, P.; Thongpool, V.; Piriyawong, V.; Asanithi, P. Procedia Engineering 2012, 32, 1100-1106.
21. Gordon, I. A. J.; Grugeon, S.; Takenouti, H.; Tribollet, B.; Armand, M.; Davoisne, C.; Débart, A.; Laruelle, S. Electrochimica Acta 2017, 223, 63-73.
22. D. Pérez-Coll, E. Sánchez-López and G. C. Mather, Solid-state Ionics, 2010, 181, 1033-1042.
23. J.-M. Doux, L. Leguay, A. Le Gal La Salle, O. Joubert and E. Quarez, Solid-state Ionics,
2018, 324, 260-266.
24. Jiang, J.; Lin, Z.; Ju, Q.; Ma, Z.; Zheng, C.; Wang, Z. Energy Procedia 2017, 105, 844-849.
25. Tomaszewska, A.; Chu, Z.; Feng, X.; O'Kane, S.; Liu, X.; Chen, J.; Ji, C.; Endler, E.; Li, R.; Liu, L.; Li, Y.; Zheng, S.; Vetterlein, S.; Gao, M.; Du, J.; Parkes, M.; Ouyang, M.; Marinescu, M.; Offer, G.; Wu, B. 2019, 1, 100011.
26. Lu, L.; Han, X.; Li, J.; Hua, J.; Ouyang, J. Power Sources 2013, 226, 272-288.
27. B. V. Ratnakumar et. Al., Journal of Power Sources, ISSN 0378-7753, 159 (2006), 1428-1439

1. A solid-state battery anode composition comprising a graphitic material and a solid electrolyte material, wherein the graphitic material is provided in the form of ground primary graphite particles.

2. The anode composition of claim 1, wherein the ground primary graphite particles have a D₅₀ of:
(i) less than about 15 microns;
(ii) less than about 10 microns; or
(iii) in the range of about 4 to 6 microns.

3. The anode composition of claim 1, wherein the ground primary graphite particles have a surface area (BET) of:
(i) about 2 to 9 m²/g; or
(ii) 7 to 9 m²/g.

4. The anode composition of claim 1, wherein the ground primary graphite particles have XRD characteristics of one or more of a d002 of >3.35 Å, an Lc of >1000 Å and an La of >1000 Å.

5. The anode composition of claim 1, wherein the ground primary graphite particles have XRD characteristics of each of a d002 of >3.35 Å, an Lc of >1000 Å and an La of >1000 Å, and a purity of >99.9%.

6. The anode composition of claim 1, wherein the solid electrolyte material comprises a sulphide-based glass.

7. The anode composition of claim 6, wherein the sulphide-based glass:
(i) is chosen from the group of Li₂S—SiS₂, Li₂S—P₂S₅ and Li₂S—B₂S₃; or
(ii) comprises Li₂S—P₂S₅.

8. The anode composition of claim 1, wherein the anode composition comprises a graphitic material and a solid electrolyte material in the following proportions:
(i) Graphitic material 70 to 90 wt %; and
(ii) Solid-electrolyte material 10 to 30 wt %.

9. The anode composition of claim 1, wherein the composition provides, in half cell measurements using the Current Rest Method, an equilibrium component of:
(i) less than about 60 Ohm; or
(ii) less than about 54 Ohm.

10. The anode composition of claim 1, wherein the solid-state battery anode composition of the present invention provides a conductivity of 10˜2×10 S/cm over a compression density range of 0.5˜2 g/cm³.

11. The anode composition of claim 1, wherein the graphitic material has a graphitisation degree of greater than about 96%.

12. The anode composition of claim 1, wherein the graphitic material has a bulk resistance of:
(i) about 359.5Ω at 100 MPa;
(ii) about 94.7Ω at 300 MPa; or
(iii) about 73.5 I at 500 MPa.

13. The anode composition of claim 1, wherein the composition provides, in half cell measurements, a capacity of:
(i) greater than 90% at 3 C; or
(ii) about 91.6% at 3 C.

14. The anode composition of claim 1, wherein the composition provides, in half cell measurements, a discharge profile substantially free of polarisation effects.

15. A method for producing a solid-state battery anode, the method comprising:
providing an anode composition that comprises a graphitic material and a solid electrolyte material, wherein the graphitic material is provided in the form of ground primary graphite particles; and
forming a battery anode with the anode composition.
